(19) United States
(12) Patent Application Publication
(10) Pub. No.: US 2014/0245124 A1
(43) Pub. Date: Aug. 28, 2014

(54) SYSTEM AND METHOD THEREOF FOR BROWSER AGNOSTIC EXTENSION MODELS

(71) Applicant: VISCOM MEDIA INC., Broassard (CA)

(72) Inventor: Miguel Enrique Cepero Gonzalez, Brossard (CA)

(73) Assignee: VISICOM MEDIA INC., Brossard (CA)

(21) Appl. No.: 13/777,057

(22) Filed: Feb. 26, 2013

(51) Int. Cl. G06F 17/24

(52) U.S. Cl. CPC G06F 17/24
USPC 715/234

(57) ABSTRACT

A method and system for web browser agnostic functionality extension. The method comprises injecting, to a web-page requested by at least a web browser executed by a client system, a bootstrap script for execution of at least an extension to the web browser; retrieving an extension script by means of the bootstrap script, wherein the extension script is executed in the web page; and establishing a two-way communication channel between the bootstrap script executed in the web browser and an extension engine, wherein events generated by either the extension engine or the extension script are communicated over the two-way communication channel, wherein the events generated by the extension engine allow to at least modify content of the web page, thereby extending the functionality of the web page.

### TECHNICAL FIELD

This invention generally relates to browser extensions, and more specifically to such systems that extend the functionality of web content.

### BACKGROUND

Web browsers are software applications that enable the viewing of information accessible on the World Wide Web (or Web). At its most basic, the Web is a collection of documents written using programming languages that web browsers can interpret. Such languages include, for example, a hypertext markup language (HTML), Java Script (JS), an eXtensible markup language (XML), and the like. Microsoft® Internet Explorer®, Mozilla Firefox®, Safari®, Google Chrome® and Opera® are but a few examples of such commonplace web browsers.

These days there are numerous web browsers that are configured to provide third parties with an ability to add new functionality by adding extensions to the web browser. However, current solutions seem not to perform well, resulting in limited capabilities of the extensions. One such noticeable deficiency is that each functional extension to a web browser is required to be designed in a way that fits the extension system of that particular web browser as known at the time of development. This generally means that it is necessary to develop the same extended functionality that is unique to each web browser, independent of any other web browser.

There also exists a class of web browsers that do not provide any kind of extension system. In such cases, it is impossible to provide extended functionality to such web browsers. Therefore, such web browsers tend not to be able to address advances that may otherwise be provided by interested third parties, or be otherwise capable in providing such extended functionality.

Therefore, it would be advantageous to overcome the limitations of the prior art by providing an effective way of handling functionality extensions of web browsers.

### SUMMARY

Certain embodiments disclosed herein include a method for web browser agnostic functionality extension. The method comprises injecting, to a web-page requested by at least a web browser executed by a client system, a bootstrap script for execution of at least an extension to the web browser; retrieving an extension script by means of the bootstrap script, wherein the extension script is executed in the web page; and establishing a two-way communication channel between the bootstrap script executed in the web browser and an extension engine, wherein events generated by either the extension engine or the extension script are communicated over the two-way communication channel, wherein the events generated by the extension engine allow to at least modify content of the web page, thereby extending the functionality of the web page.

Certain embodiments disclosed herein include an extension engine for providing web browser agnostic functionality extension. The extension engine comprises a hypertext transfer protocol (HTTP) proxy configured to inject a bootstrap script to a web page rendered by the web browser, thereby enabling the execution of the bootstrap script in the rendered web page; a local HTTP server configured to provide a communication interface between the bootstrap script and the extension engine; and an extension processor configured to execute an extension application expanding the functionality of the web server.

### BRIEF DESCRIPTION OF THE DRAWINGS

The subject matter that is regarded as the invention is particularly pointed out and distinctly claimed in the claims at the conclusion of the specification. The foregoing and other objects, features and advantages of the invention will be apparent from the following detailed description taken in conjunction with the accompanying drawings.

FIG. 1 is a schematic diagram of a system configured with a bootstrap script operative with respect of a local HTTP server to support an extension process according to an embodiment.

FIG. 2 is a schematic diagram of a system configured with a bootstrap script operative with respect of a local HTTP server supporting an extension process and further operative with respect of an external extension web server according to an embodiment.

FIG. 3 is a flowchart describing an operation of a bootstrap script according to an embodiment.

FIG. 4 is a flowchart describing an operation of the web browser extension according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

Certain embodiments disclosed herein include techniques for providing an extended browser functionality based on the programmable code that can be rendered by web browsers. Such code includes, for example, hypertext markup language (HTML), Java Script (JS), an eXtensible markup language (XML), and the like. The disclosed techniques identify client systems executing a web browser for the purpose of displaying web content for the installation of a bootstrap script.

According to one embodiment, the disclosed extended browser functionality realized by the bootstrap script and extension engine that are independent of the web browsers, thus allowing extending the functionality of both browsers having extension capabilities as well as those that do not. Furthermore, the bootstrap script and the extension engine are programmed to provide the same functionality extension solution suitable for use independent of each web browser.

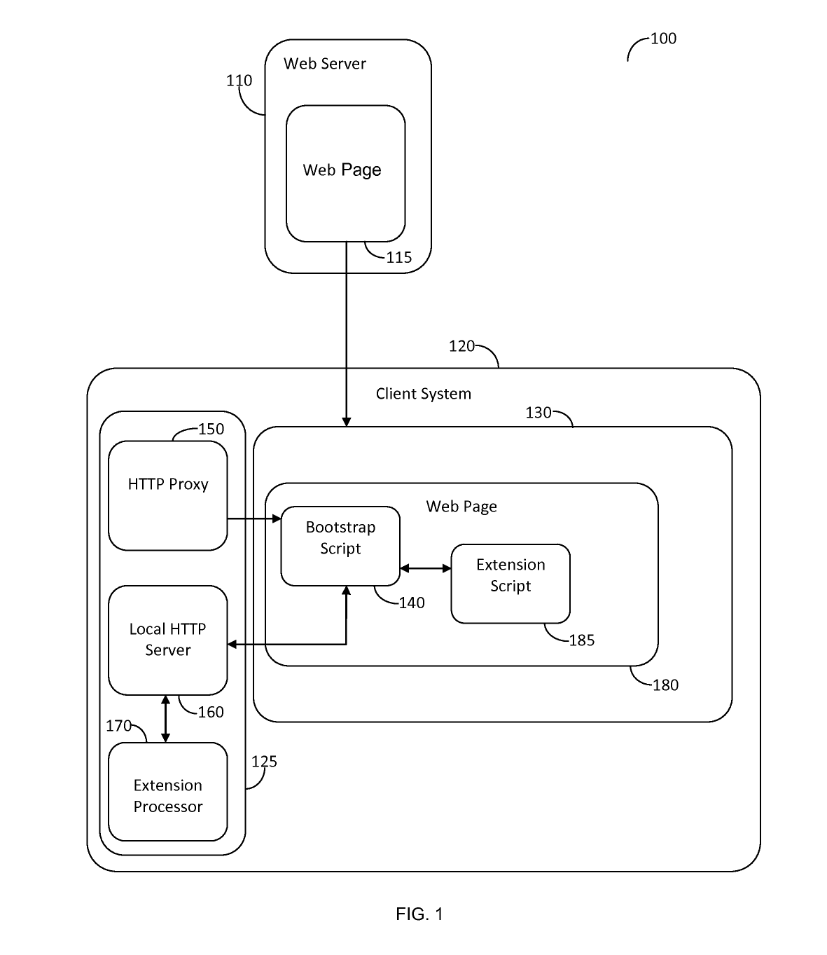

FIG. 1 is an exemplary and non-limiting schematic diagram of a system 100 configured with a bootstrap script operative with respect of a local HTTP server to support an extension process according to an embodiment. A client system 120 is configured with a web browser 130. A web server 110 communicates with the client system 120 to provide one or more web-page 115 processed and displayed by the web browser 130.

According to an embodiment disclosed herein, the client system 120 includes an extension engine 125 that provides extended browser functionality independent of the web browser 130. The extension engine 125 may be included in the client system 120 through an installation process. In one embodiment, illustrated in FIG. 1, the extension engine 125 comprises an HTTP proxy 150, a local HTTP server 160, and an extension processor 170. The extension processor 170 is configured to execute extension applications. Such applications determine the interaction with a web page 180 for the purpose of expanding the browser functionality. The extension applications may be saved in the extension engine 125 or downloaded from a remote server.

The injection of the bootstrap script 140 is performed using a local HTTP proxy 150 or a similar entity that are configured to modify the network stack of the web browser to allow the bootstrap script 140 to be executed as part of the web page 180. The web browser 130 may be any a software application for processing web pages, such as Microsoft® Internet Explorer®, Mozilla Firefox®, Safari®, Google Chrome®, Opera®, and the like. The client system 120 may be any computing device including at least one processor and a tangible memory (not shown) for storing instructions processed by at least one processor. The client system 120 may be, for example, a personal computer, a laptop computer, a tablet computer, a smart phone, and the like.

In order to enable an extended browser functionality, a bootstrap script 140 is utilized. In a preferred embodiment, the processor of the client system 120 (not shown) processes the instructions of the bootstrap script 140. The bootstrap script 140 is added to each web page (e.g., page 180) downloaded to the web browser 130 that requires the use of the extended functionality. Once a user navigates from a web-page or closes the browser (or a tab) the bootstrap script 140 included therein is terminated. Any time that a new web-page is downloaded to the web-browser 130, an instance of the bootstrap script 140 is injected into the downloaded web page. In one embodiment, as shown in FIG. 1, an instance of the bootstrap script 140 is injected by the HTTP proxy 150 or any other similar component configured to modify the network stack of the browser 130.

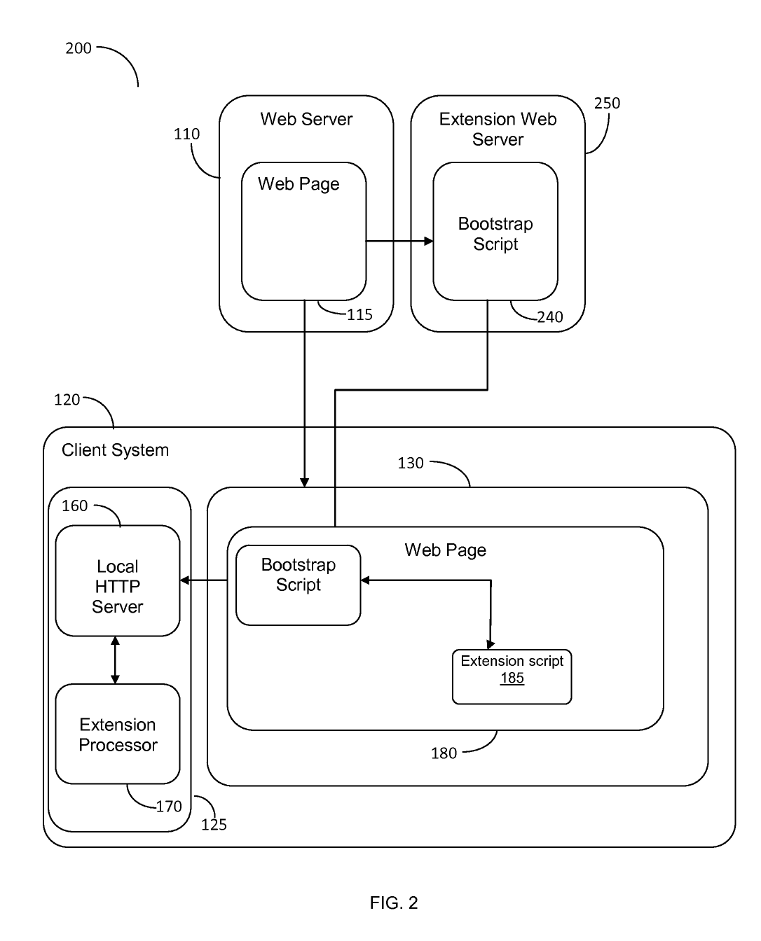

In another embodiment, shown in FIG. 2, the script 140 is added through an external web server 250. With this aim, the web-page (115) being downloaded includes a link to the bootstrap script 240 in an extension web server 250. The bootstrap script 240 is downloaded together with the web page 115 to the web browser 130. The bootstrap script 240 is executed in the browser 130 as the bootstrap script 140. In the embodiment illustrated in FIG. 2, the extension engine 125 comprises a local HTTP server 160 and an extension processor 170. Therefore, in such configuration, the engine 125 does not include an HTTP proxy 160, as there is no need to modify the network stack to inject the script 140.

One of the tasks of the bootstrap script 140 is to provide the extension engine 125 with two-way communication with the web page 180 rendered by the browser 130. Once the bootstrap script 140 runs as part of the web page 180, the script 140 retrieves, or downloads, an extension script 185 from the local HTTP server 160. The extension script 185 extends the functionality of the web page 180 as determined by an application executed by the extension engine.

In one embodiment, the two-way communication channel is facilitated through the local HTTP server 160. With this aim, the local HTTP server 160 is configured to create a two-way communication channel to allow communication of an extension application executed by the extension processor 170 with the extension script 185 that runs in the web page 180. The two-way communication channel enables the extension of the functionality of the web page 180 within the web browser 130. Specifically, any events sent by the extension processor 170 are immediately delivered to the extension script 185 executed as part of the web page 180, and events captured by the extension script 185 flow from the web browser 130 into the extension processor 170 and are mapped over HTTP calls to the local HTTP server 160. In one embodiment, the two-way communication may be a reverse Asynchronous JavaScript and XML (AJAX), a HTML5 Web socket, and the like.

For example, if the extension application executed by the extension processor 170 is to provide an update to a Facebook® page of the user, then the extension script 185 monitors events on the web page 180 related to Facebook and communicates such events back to the extension processor 170. For instance, if the user read an article on a web-page from CNN.com on the browser and clicks “Like”, such an event is sent back to the extension processor 170 to create an update on the user's Facebook page.

According to other embodiments, the extension script can be also configured to extend existing links in the web page 180 by adding, e.g., information and images, changing formatting and appearance of the web page 180, and creating new sections in the page that interact with content and applications installed in the client system 120.

In one embodiment, a database (not shown), may be an integral part of the memory, or a separate entity coupled to the processor. The database contains a reference to the extension script 180. The extension script 185 is based on programming code standards such as, JavaScript, a HTML, an XML, and the like, but not limited thereto.

In yet another embodiment, the local HTTP server 160 is configured to generate a key to obtain a security token. The token is used to prevent the extension script 180 from being executed on the web page 180. Thus, the key may prevent the communication between the web page 180 and the local HTTP server 160 when the token is not authentic. In another embodiment, once the extension script 185 is executed on the web page 180, the web server 110 is configured to perform outside of the web browser process that is executed on the client system 120.

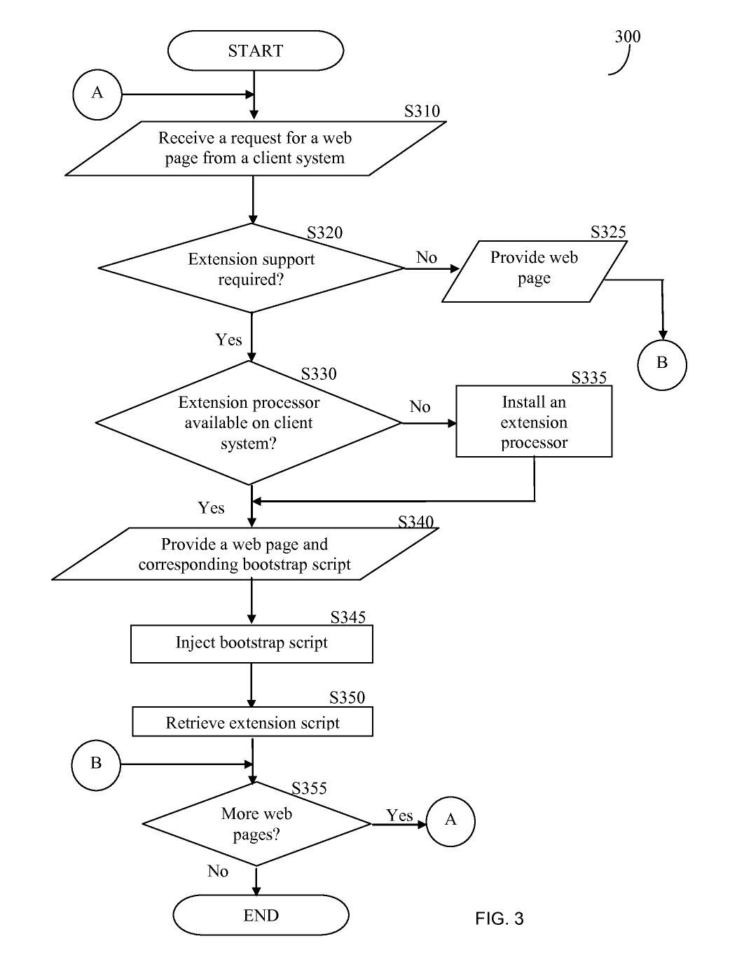

FIG. 3 shows an exemplary and non-limiting flowchart 300 describing the process of injecting a bootstrap script for the expanding the functionality of a web browser according to an embodiment. In S310, the operation starts when a request to receive a web-page is received from the client system 120. In S320, it is checked whether the web browser's requested web-page requires an extended functionality. If so, execution continues with S330; otherwise, execution continues with S325 where the web page is provided, after which execution continues with S355.

In S330 it is checked if the client system 120 supports the web browser extension by an extension processor 170. If not, in S335, the extension engine is installed on the client system 120 and the extension processor 170 is configured for operation on the client system 120; otherwise, execution continues with S340.

In S340, the web server 110 provides a web page that includes the bootstrap script 140, or a link therein to a script 240. In S345, the bootstrap script 140 is injected to the downloaded web page by means of the proxy 150 or any entity that can modify the network stack. Alternatively, the bootstrap script 240 is downloaded from an extension web server through a link in the web requested by the web server. In this embodiment, the network stack is not modified. The bootstrap script 140 is downloaded together with the web page and is configured to be executed in the web page 180. The downloaded script 140 is active only during a session when the associated web page is active. That is, if the user navigates away from the downloaded web-page or closes the browsers the bootstrap script 140 becomes inactive.

At S350, once the bootstrap script 140 runs as part of the web page 180, the script 140 retrieves an extension script 185 from the local HTTP server 160. As noted above, the extension script extends the functionality of the web page 180 as determined by the extension engine 125. That is, once the extension script 185 is downloaded to the web-page by the bootstrap script 140 any logic provided by the extension engine 125 is applied to the web page 180.

It should be noted that the size of the extension script 180 is larger than the bootstrap script (140 or 240). The extension script 120 is locally saved in the client system 120, thus can be immediately provided to the web browser 130. It should be further noted that the local HTTP server 160 can be preinstalled with a plurality of extension scripts and additional scripts or updated scripts may be downloaded and stored in the local HTTP server on an as needed basis. Such operation may be performed regardless of the state of the bootstrap script 140.

In S355, it is checked whether there are additional requests for additional web pages, and if so execution continues with S310; otherwise, execution terminates.

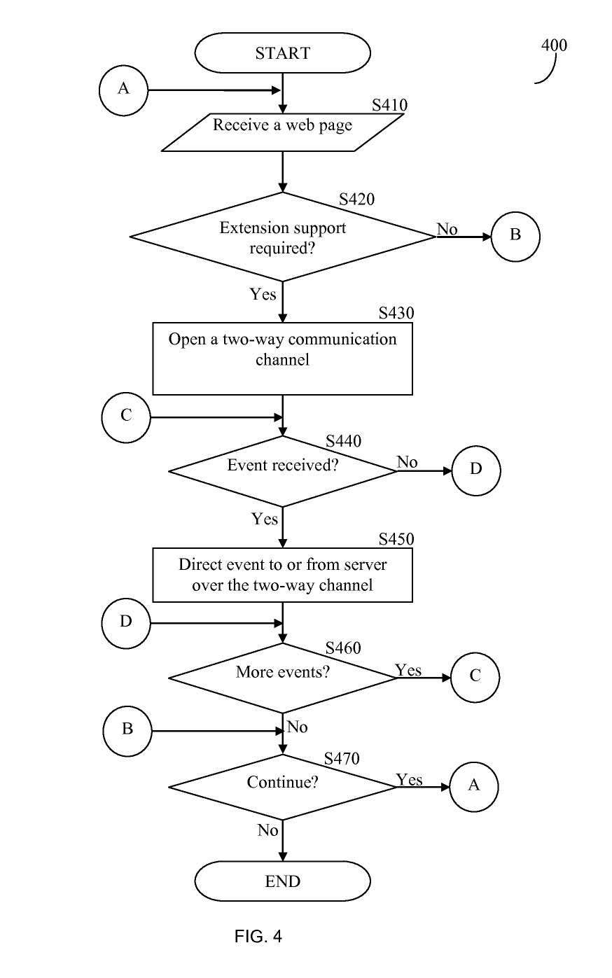

FIG. 4 depicts an exemplary and non-limiting flowchart 400 of the operation of the browser extension according to one embodiment. In S410, a web page requested by the web browser is downloaded together with a bootstrap script to the web browser as discussed above at least with respect to FIG. 3. In S420, the bootstrap script 140 is executed in the downloaded web page 180 and the extension script 185 is retrieved from the local HTTP server 160 as discussed above. In S430, a two-way communication channel is established between the bootstrap script 140 executed in the web browser 130 and the extension engine 125. Specifically, over the two-way communication channel, events, actions, and information are transferred between the extension application executed by the extension processor 170 and the extension script 185 in the web browser 130, thus enabling extension of the functionality of the web browser. In S440, it is checked whether an event is received, and if so execution continues with S450; otherwise, execution continues with S460. In S450 the event is directed over the two-way communication channel to either the web page 180 rendered by the web browser or to the processor 170 executing the extension application.

The extension application executed by the extension processor 170 can reply to the events received from the extension script by sending information or by performing actions. It should be noted that as the extension application is executed in the client system 120 in a user domain, the extension application can access any local data and perform any task that involves accessing local resources of the client system 120. The events captured by the extension script are first delivered to the local HTTP server 160 by means of the bootstrap script, which uses Inter Process Communication to relay the event to the extension processor 170.

Sending events and information from the processor 170 to the extension script 185 is achieved by having a keep-alive connection to the local HTTP server 160 and streaming script commands through the server 160 and the bootstrap script 140.

In S460 it is checked whether additional events are to be processed and if so, execution continues with S440; otherwise, execution continues with S470 where it is checked whether to continue, and if so, execution continues with S410; otherwise, execution terminates.

The embodiments disclosed herein may be implemented in hardware, software, firmware or any combinations thereof. The software may be implemented as an application program tangibly embodied on a program storage unit or computer readable medium. The application program may be uploaded to, and executed by, a machine comprising any suitable architecture, for example a computer platform having hardware such as one or more central processing units (“CPUs”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown.

It is to be further understood that, because some of the constituent system components and methods depicted in the accompanying drawings are preferably implemented in software, the actual connections between the system components or the process function blocks may differ depending upon the manner in which the present invention is programmed. Given the teachings herein, one of ordinary skill in the pertinent art will be able to contemplate these and similar implementations or configurations of the present invention. All examples and conditional language recited herein are intended for pedagogical purposes to aid the reader in understanding the principles of the invention and the concepts contributed by the inventors to furthering the art, and are to be construed as being without limitation to such specifically recited examples and conditions.

All statements herein reciting principles, aspects, and embodiments of the invention, as well as specific examples thereof, are intended to encompass both structural and functional equivalents thereof. It is intended that such equivalents include both currently known equivalents as well as equivalents developed in the future, i.e., any elements developed that perform the same function, regardless of structure. Other hardware, conventional and/or custom, may also be included.

What we claim is:

1. A method for web browser agnostic functionality extension, comprising:
injecting, to a web-page requested by at least a web browser executed by a client system, a bootstrap script for execution of at least an extension to the web browser;
retrieving an extension script by means of the bootstrap script, wherein the extension script is executed in the web page; and
establishing a two-way communication channel between the bootstrap script executed in the web browser and an extension engine, wherein events generated by either the extension engine or the extension script are communicated over the two-way communication channel, wherein the events generated by the extension engine allow to at least modify content of the web page, thereby extending the functionality of the web page.

2. The method of claim 1, further comprising:
configuring the extension engine on the client system responsive to an identification that such an extension engine is not configured on the client system.

3. The method of claim 1, wherein the bootstrap script renders code compatible with any one of: a JavaScript, a hypertext markup language (HTML), eXtensible markup language (XML).

4. The method of claim 1, wherein the bootstrap script is injected to the web page by means of a proxy server included in the client system.

5. The method of claim 1, wherein the bootstrap script is downloaded to the web browser any one of: a local HTTP server included in the client system and an extension web server.

6. The computerized method of claim 4, wherein establishing a two-way communication channel further comprising:
generating any one of: a reverse Asynchronous JavaScript And XML (AJAX) channel and a HTML5 Web socket.

7. The computerized method of claim 1, further comprising:
generating a key to obtain a security token.

8. The computerized method of claim 7, further comprising:
enabling the execution of the extension script on the web page content upon authentication of the token.

9. The computerized method of claim 1, wherein the at least web browser is any one of: Microsoft Internet Explorer, Mozilla Firefox, Safari, Google Chrome, and Opera.

10. A non-transitory computer readable medium having stored thereon instructions for causing one or more processing units to execute the method according to claim 1.

11. A client system configured for functionality extension of at least a web browser installed thereon, comprising:
at least an interface for receiving a web page requiring extension of the web browser functionality;
a processing system coupled to the at least an interface for processing the web page and executing the web browser; and
a memory coupled to the processing system, containing a plurality of instructions that when executed by the processing system configures the client system to: execute the web browser for display of the web page on a display coupled to the client system; execute a bootstrap script received with the web page; execute an extension engine on the client system for execution of the extension content of the web page thereby extending the functionality of the web browser, wherein the content extension is browser agnostic.

12. The client system of claim 11, wherein the bootstrap script renders code compatible with any one of: a JavaScript, a hypertext markup language (HTML) and an eXtensible markup language (XML).

13. The client system of claim 11, wherein a two-way communication channel is established between the bootstrap script executed in the web browser and the extension engine.

14. The client system of claim 11, wherein the bootstrap script is further configured to:
retrieve an extension script; and
operate over the two-way communication channel, wherein events generated by either the extension engine or the extension script are communicated over the two-way communication channel, wherein the events generated by the extension engine allow to at least modify content of the web page, thereby extending the functionality of the web page.

15. The system of claim 14, wherein the two-way communication channel is any one of: a reverse Asynchronous JavaScript and XML (AJAX) channel and a HTML5 Web Socket.

16. An extension engine for providing web browser agnostic functionality extension, comprising:
a hypertext transfer protocol (HTTP) proxy configured to inject a bootstrap script to a web page rendered by the web browser, thereby enabling the execution of the bootstrap script in the rendered web page;
a local HTTP server configured to provide a communication interface between the bootstrap script and the extension engine; and
an extension processor configured to execute an extension application expanding the functionality of the web server.

17. The extension engine of claim 16, wherein the local HTTP server is further configured to store at least one extension script, wherein the extension script is retrieved by the bootstrap script for execution in the rendered web page.

18. The extension engine of claim 17, wherein the local HTTP server is further configured to:
establish a two-way communication channel between the extension processor and the bootstrap script in response to a request received from the bootstrap script, wherein events generated by any one of the extension engine and the extension script are communicated over the two-way communication channel

19. The extension engine of claim 18, wherein the events generated by the extension engine allow to at least modify content of the web page, thereby extending the functionality of the web page.

20. The extension engine of claim 16, wherein the extension script extends the functionality of the web page as respective of the execution of the extension application by the extension processor.
